(19) United States
(12) Patent Application Publication
(10) Pub. No.: US 2018/0135150 A1
(43) Pub. Date: May 17, 2018

(54) PURIFYING AN ALLOY MELT

(71) Applicant: Brunei University London, Uxbridge Middlesex (GB)

(72) Inventors: Zhongyun Fan, Uxbridge Middlesex (GB); Shouxun Ji, Uxbridge Middlesex (GB); Ian Stone, Uxbridge Middlesex (GB)

(21) Appl. No.: 15/550,241

(22) PCT Filed: Mar. 11, 2016
(86) PCT No.: PCT/GB2016/050679

§ 371 Date: Jan. 5, 2018

(30) Foreign Application Priority Data
Mar. 13, 2015 (GB) 1504296.3

(51) Int. Cl. C22C 3/00; C22C 21/00; C22B 9/05; B01F 7/00

(52) U.S. Cl. CPC C22C 3/005; C22C 21/00; B01F 2215/0075; B01F 7/00816; B01F 7/00925; C22B 9/05

(57) ABSTRACT

Device and method for melt treatment of aluminium alloys having excessive inclusions, impurities and unwanted gases to be removed, by (a) cooling the melt at an appropriate cooling rate to a temperature below the liquidus by shearing the melt associated with the introduction of at least one type of inert gases into the melt to form fine bubbles and high shear in the melt, and (b) purifying inclusions in the melt by floating them to the top surface, degassing the undesirable gases by reacting with the inert gas, and forming solid intermetallics containing impurity elements and transferring the melt mixture by the shearing device into a holding furnace, and (c) maintaining the melt in the holding furnace at a temperature below the liquidus and above the solidus temperature to settle the solid intermetallics formed by impurity elements as sediment at the bottom of the holding furnace while flowing the melt with much reduced inclusions, impurities and unwanted gases out of the holding furnace as applicable materials. The method is advantageously applicable for upgrading aluminium alloys from recycled and/or scrapped materials.

The present invention relates to a device and method for separating impurities from an alloy melt, and in particular for separating excessive inclusions, impurity elements and undesirable gases from aluminium alloys.

Contaminations of aluminium alloys by inclusions, undesirable gases and impurity elements always occur during recycling of aluminium products using scrapped and recycled materials. Aluminium alloys containing substantial amounts of inclusions, undesirable gases and impurity elements are usually suitable only for low-end uses and are not suitable for use in industry. Because inclusions, undesirable gases and impurity elements are significantly detrimental to the formability and fracture mechanics of aluminium alloy products, only small amounts can be tolerated in the alloys. In order to address this issue, the excessive inclusions, undesirable gases and impurity elements need to be removed during manufacturing of ingots. This is not only technically important, but also economically very profitable as it allows scraped metals which usually contain high level of inclusions, un-wanted gases and impurity elements to be processed to regain a higher economic value.

A number of purification methods are known in the prior art. The removal of undesirable gases that naturally dissolve in the molten metal has been a common processing method over the world. It has been proved that hydrogen dissolves significantly in molten aluminium and is subsequently released during solidification due to decreasing solubility, which causes undesirable porosity defects in products. Introduction of inert or chemically inactive gas into molten aluminium has been known as an effective treatment of the molten metal by reducing the levels of unwanted and dissolved gases.

A method of bubbling argon, nitrogen, or a similar inert gas through molten aluminium is effective to remove dissolved hydrogen from the molten aluminium. As the bubbles of gas rise to the melt surface, dissolved hydrogen diffuses into the inert gas bubbles and is desorbed from the melt and released into the air above the surface of the melt. In addition, adding a small amount of chlorine (usually 0.5% or less) to the process gas breaks the bond between the aluminium and any non-wetted inclusions present in the melt, and helps to remove alkali metals, allowing the chlorine to react with the alkali metals and the rising gas bubbles to stick to the inclusions, floating the impurities to the melt surface. In other words, bubbling inert gas through molten metal is effective in treating the molten metal on multiple levels. Therefore, the gas injection method becomes critical.

A variety of degassing methods have been employed, including those using rotating nozzles and stationary degassers without moving or rotating parts. However, methods that can produce fine bubbles in the aluminium melt have been proved to be preferable because of the increase in processing efficiency. As a consequence, there is an ongoing requirement for the improvement of degassing methods by providing refined gas bubbles, which can also assist in purifying inclusions as a result of an increase in the likelihood of contact between the gas and the inclusions.

Foreign chemical elements present in the aluminium melts have to be removed in order to purify the aluminium alloys. Ideally, intermetallics containing one or more foreign elements as solid inclusions should be formed as a prior phase during solidification of the alloys. When more than one foreign chemical element is present and the molten aluminium is cooled, first one inter-metallic compound or crystals containing only one foreign element is/are formed, and after that a second or even third or further inter-metallic compounds or crystals will be formed. Several techniques are known for the removal of the inter-metallic compounds or crystals, such as gravity sedimentation, flotation, filtration, centrifugation, electromagnetic sedimentation, or ultrasonic treatment.

The most common method is gravity sedimentation, in which the sediment at the bottom of the melting crucible is enriched by impurity elements because of its higher density in comparison with that of aluminium. Gravitational separation can achieve a low impurity level but needs a long settling time. The combination of gravitational separation and filtration gives impressive iron removal results, but the disadvantages during gravitational separation step are still there, in addition to the problem of clogging of filter pores. The other drawback is that the gravity sedimentation technique is usually not continuous and not integrated with other melt treatment processes. As a result, there is an ongoing need in the art for developing a method and device that is capable of providing a continuous melt treatment for purifying the excessive inclusions, undesirable gases and impurity elements in aluminium alloys.

U.S. Pat. No. 4,772,319 (Showa Aluminium Corporation) discloses a method of removing hydrogen gas and non-metallic inclusions from molten aluminium by a process comprising the steps of rendering the portion above the surface of molten aluminium in a treating vessel and supplying treating gas to the molten aluminium via a rotary shaft having a gas supply channel and a rotor.

Other methods for treating aluminium alloys are disclosed in U.S. Pat. No. 2,464,610; 3,900,313; and 4,917,728.

The present invention seeks to provide an improved device and method for separating impurities from an alloy melt, and in particular for separating excessive inclusions, impurity elements and undesirable gases from aluminium alloys.

In accordance with a first aspect of the present invention, there is provided a device for separating impurities from an alloy melt, including:

(a) a rotor comprising a shaft having a first end and a second end, the shaft having a longitudinal channel with an inlet proximate the first end of the shaft and an outlet proximate the second end of the shaft to allow a fluid to flow into the channel through the inlet, through the shaft and out of the channel at the outlet,

(b) a motor to rotate the shaft about its longitudinal axis, and

(c) a stator in the form of a sleeve (for example a hollow cylinder) proximate the second end of the shaft, the sleeve having a wall with at least one aperture therein, whereby in use fluid exiting the longitudinal channel of the shaft is able to pass through said aperture.

The sleeve preferably includes a plurality of apertures in the sleeve wall. These may be distributed evenly around the wall, and are preferably round with a diameter from 0.5 mm to 10 mm depending on the size of the rotor.

In a preferred embodiment, there is a gap of at least 0.1 mm between the rotor and stator to facilitate a high shear rate. There may also be a housing to integrate the stator and the rotor driven by a motor. The rotor and stator are assembled in such a way that the devices can supply high shear and sufficient pumping action to the alloy melt, which creates localised turbulent flow within the melt and creates fine bubbles of the inert gas.

In a preferred embodiment, the shaft has at least one vane proximate the second end to form an impeller structure. The impeller is able to generate a centrifugal flow against the stator wall in order to provide a pumping action.

The combination of the shaft for supplying a fluid (for example an inert gas) and the rotor/stator for supplying shear to the alloy melt enables the device to be deployed in a method for separating impurities from an alloy melt. In a second aspect of the present invention, this method includes the steps of:

(a) providing a melt of the alloy in a first vessel, and including the following steps in any order:

(b) deploying a device as defined above and rotating the rotor in order to shear the melt,

(c) deploying a device as defined above and supplying to the alloy melt an inert gas by causing said gas to flow along the longitudinal channel of said device from the first end to the second end of the shaft in order that the gas exits the shaft, forms gas bubbles in the alloy melt, and passes through the aperture in the sleeve wall, and

(d) reducing the temperature of the alloy melt to below its liquidus but above its solidus,

in order to cause impurities to collect at the top surface of the melt, at the bottom of the vessel or to dissolve in the gas bubbles.

In a preferred embodiment, the method additionally includes the step of:

(e) after steps (a) to (d), transferring at least some of the alloy melt to a second vessel and leaving at least some impurities in the first vessel. Preferably, the temperature of the alloy in the second vessel is maintained above its solidus but below its liquidus.

The method may additionally include the step of:

(f) after step (e), removing at least some of the alloy from the second vessel and leaving at least some impurities in the second vessel.

In an alternative aspect of the invention, there is provided a method and device of melt treatment for the purification and separation of the excessive inclusions, un-wanted gases and impurity elements from an aluminium alloy melt comprising the steps of: (a) cooling the melt at an appropriate cooling rate to a temperature below the liquidus by shearing the melt associated with the introduction of at least one type of inert gases into the melt to form fine bubbles and high shear in the melt, and (b) purifying inclusions in the melt by floating them to the top surface, degasing the undesirable gases by reacting with the inert gas, and forming solid intermetallics containing impurity elements and transferring the melt mixture by the shearing device into a holding furnace, and (c) maintaining the melt in the holding furnace at a temperature below the liquidus and above the solidus temperature to settle the solid intermetallics formed by impurity elements as sediment at the bottom of the holding furnace while flowing the melt with much reduced inclusions, impurities and unwanted gases out of the holding furnace as applicable materials.

The shearing may be applied for inclusions removal by affixing and floating them with the refined inert gas bubbles, the unwanted gases removal by reaction with the refined inert gas bubbles, and the excessive impurity elements removal by promoting the formation of solid intermetallics through the chemical reaction between the impurity elements and the additives or the element from the alloy compositions.

The shearing device may contain a rotor and stator, in which the rotor is encircled by a round stator with numerous holes on the wall stator and is associated with inert gas supply, by which the inert gas is broken into fine bubbles and dispersing the bubbles throughout the melt during shearing the melt to provide the required cooling rates.

The temperature may be cooled and maintained consistently or slightly variation by shearing the melt and bubbling the inert gas in the shearing furnace.

The cooling and shearing may start from a temperature above the liquidus temperature to a temperature below its liquidus temperature, but above its solidus temperature. The cooling and shearing may start from a temperature below the liquidus but above the solidus.

The solid intermetallics may be generated in the melt during quick cooling and shearing in the shearing crucible and immediately pumped into the holding furnace and maintained at the same temperature for the sediment of the solid intermetallics.

In the method according to the present invention the aluminium alloys to be treated have excessive inclusions, un-wanted gases and impurity elements. In reality, at least one intermetallic crystal can be generated in situ during solidification of the alloy according to the equilibrium phase diagram. After the aluminium alloy is melted into a liquid state, the melts may be subjected to composition modification by adding at least one of Si, Mn, Mg, Co, Cr and Ni. Although the amounts of these elements can be varied in a large range for an individual alloy, it is preferred that their amounts are equal to about 0.2 to 2.5 times of the total weight of impurity elements present, by which the composition of the aluminium melt forms the prior phase as intermetallics when solidification occurs.

The aluminium alloy melt is preferably subjected to an intensive shearing process together with at least one inert gas, during which the inert gas is divided into the fine bubbles that provide at least two roles: quick cooling of the melt and purification of the melt by degassing and cleaning the inclusions. The solid intermetallic phases formed during cooling are pumped to a holding furnace to be maintained at the same temperature. The intermetallic phases containing impurity elements inside the melt are settled as sediments at the bottom of the holding furnace. The inclusions and unwanted gases are affixed to the inert gas bubbles to be pushed to the top surface of the aluminium melts to form sludge for skimming.

The aluminium alloy melt is cooled to a temperature below the liquidus to form intermetallic crystals, and shearing is applied during the cooling process or even before the cooling commences, while the temperature is maintained consistently or slightly varied in the partial solidification. If the initial impurity content is high in the aluminium melt or the final impurity concentration is required to be at a low level, it might take multiple stages of composition adjustment and cooling to create the required solid crystals.

The melt is cooled down from a temperature above the liquidus to a temperature below the liquidus but above the solidus and is pumped by a high shear device to a holding crucible which is essentially maintained at the same temperature as the melt. The holding crucible is structured to receive the melt after it has been sheared and then to discharge the melt, during which time the solid intermetallic phase inside the melt is settled as sediment at the bottom of the holding crucible so that the melt discharged from the holding crucible contains many fewer impurity elements.

The melt prior to entering the holding crucible is a mixture of solid and liquid states, and so there is no requirement of temperature variation in the holding crucible. The separation process between the solid and the liquid can be achieved in a short period of time. The method of the present invention therefore provides a fast and easy way to purify aluminium alloy melts, in particular those made from scrap materials.

The shearing device provides a continuous process with a pumping function and the shearing time is preferably within 3 minutes, or even more preferably within 1 minute from entering to flowing out of the shearing device. The advantages of the method and device also include process integration, lower sensitivity to the alloy composition, lower loss of other elements, and easy operation on a large scale. Moreover, the method offers a low processing cost and is feasible for large-scale industrial application. The method and device of the present invention also enables integrated degassing and removal of inclusions and impurity elements in one step.

In a preferred embodiment, an alloying element is added comprising at least one element chosen from Si, Mn, Mg, Cr, Co and Ni. These elements are added as additives either individually or in combination, in order to form intermetallics easily with impurity elements at the beginning stage of solidification. At least one intermetallic phase can be obtained at the beginning stage of solidification. For instance, when iron is the element to be removed, the iron content in the aluminium alloy is over 0.3 wt. %. When the Fe content is very high, multiple stages of removal process are required, in order to obtain a very low level iron in the final product. The addition of these elements may be carried out in the form of pure elements or in the form of alloys with aluminium. Advantageously the addition of the special alloying element is performed prior to the starting of shearing and bubbling.

In a preferred embodiment, the combination is needed for the proper composition adjustment of aluminium alloys with the shearing and cooling of the melt at a temperature below the liquidus temperature, during which a fraction of the prior phase of intermetallics solidifies throughout the melt. However, the formed solid intermetallics tend to settle as sediment in the shearing crucible because the density of the intermetallics is substantially greater than that of liquid aluminium. In order to avoid sediments in the shearing crucible, the shearing mechanism is developed in such a way that can provide required high cooling rate and pumping action to maintain the solid intermetallics in a suspension state in the aluminium melt.

At least one inert gas from nitrogen, argon or other gases or a mixture of these gases is introduced with a satisfactory flow rate and a proper manner at the bottom of shearing device in order to further control the cooling rate of the melt under shearing. The flow rate of the inert gas and the shear rate of the shearing device are preferably set at a value at which the top surface of the melt is not seriously broken, which prevents serious oxidation of the aluminium melt. The introduction of the inert gas is controlled in such a way that the shearing can essentially break the gas into small bubbles, which can float the inclusions to the top surface of the melt, by which the multiple functions can be achieved in an integrated system.

In a preferred embodiment, the volume fraction of the solid intermetallics in the aluminium alloy melt is determined by the shearing temperature, although the further lowering is an option in the holding furnace. Usually the lower the melt temperature below the liquidus, the higher the volume fraction of the intermetallics created in the melt, which results in a lower content of impurity elements in the melt obtained after treatment. Meanwhile, there is a partition coefficient to determine the purification efficacy of the impurity elements. It is obvious that most of the intermetallics phases present in the melt can be removed as they are denser than the liquid. If the partition coefficient is defined as the ratio of the concentration of the impurity elements in the purified alloy to the concentration of the impurity elements originally present in the alloy, the partition coefficient is preferably close to 0, although it is definitely higher than 0. The lower partition coefficient indicates the achievement of the melt treatment from the original alloys. Obviously, most of the inclusions can also be removed as they are lighter than the liquid, which is promoted by the inert gas bubbles distributed throughout the melt.

In summary, the present invention preferably relates to a device and method for melt treatment of aluminium alloys having excessive inclusions, impurities and unwanted gases to be removed, by (a) cooling the melt at an appropriate cooling rate to a temperature below the liquidus by shearing the melt associated with the introduction of at least one type of inert gases into the melt to form fine bubbles and high shear in the melt, and (b) purifying inclusions in the melt by floating them to the top surface, degassing the undesirable gases by reacting with the inert gas, and forming solid intermetallics containing impurity elements and transferring the melt mixture by the shearing device into a holding furnace, and (c) maintaining the melt in the holding furnace at a temperature below the liquidus and above the solidus temperature to settle the solid intermetallics formed by impurity elements as sediment at the bottom of the holding furnace while flowing the melt with much reduced inclusions, impurities and unwanted gases out of the holding furnace as applicable materials. The method is advantageously applicable for upgrading aluminium alloys from recycled and/or scrapped materials.

A number of preferred embodiments of the present invention will now be illustrated with reference to the drawings in which:

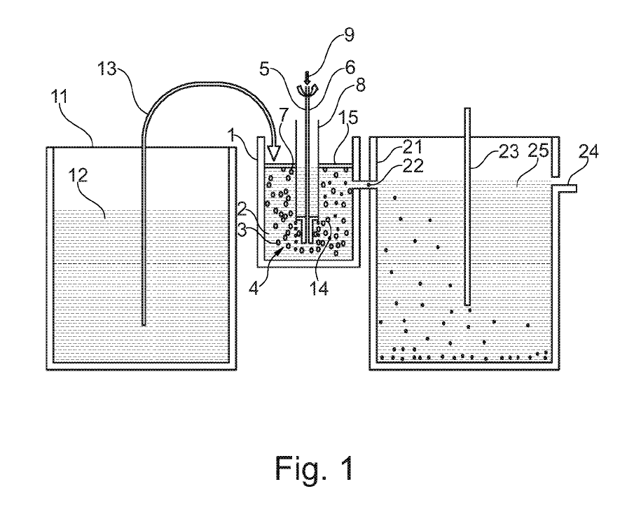

FIG. 1 is a schematic representation of an embodiment of a device according to the present invention;

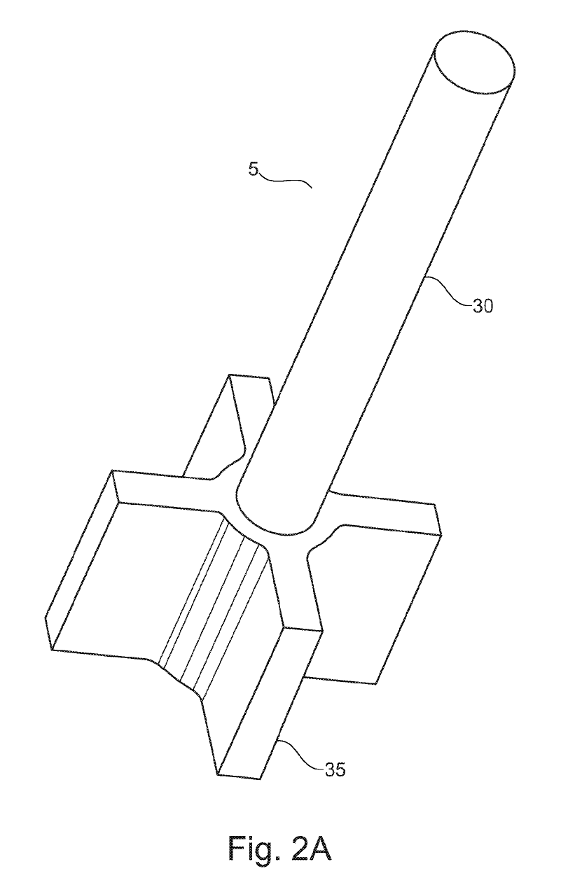

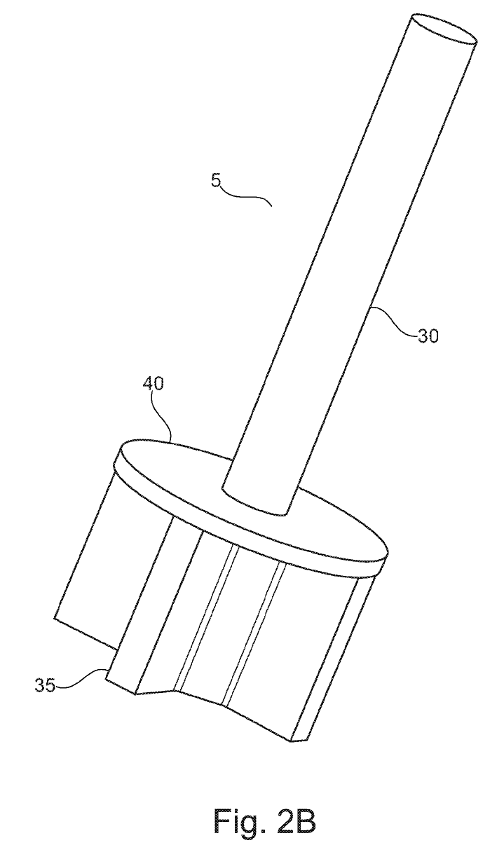

FIG. 2A is a schematic representation of a stirrer for a device in accordance with the present invention; and

FIG. 2B is a schematic representation of an alternative stirrer for a device in accordance with the present invention.

In FIG. 1, the dirty aluminium alloy melt with excessive inclusions, undesirable gases and impurity elements is melted first. A furnace 11 is usually regarded as melting furnace to supply aluminium melt 12 through a transfer tube 13 at a temperature above the liquidus to a shearing crucible 1. Then the aluminium melt 12 become the melt 2 by cooling down to a temperature below its liquidus in the shearing crucible 1, during which the sold intermetallics 3 is created in the melt.

A stirrer 5 located in a stator 8 is rotated inside the melt 2. The stator 8 is manufactured with several holes 4 on its wall and the inert gas 9 is supplied through the pipe 6 in the centre of the stirrer 5. The mechanism (not shown in FIG. 1) at one end of the stirrer 5 is used to supply shear and to break the inert gas 9 into small bubbles 7 through the holes 4, which are immediately dispersed into the melt 2. The gas bubbles 7 combine with the high shear to provide an appropriate cooling rate to create the solid intermetallics 3 in the aluminium melt 2.

The gas bubbles 7 react with dissolved gas during floating to the top surface, while affixing the inclusion 14, resulting the formation of sludge 15 on the top surface of the melt.

The simultaneous shearing and pumping action delivers the melt 2 with solid intermetallics into the holding furnace 21 through the connecting tube 22. At least one separator 23 is located in the middle of the holding crucible 21. The solid intermetallics 3 are settled as sediment in the holding crucible 21 to leave the melt 25 with much less iron content in comparison with the original melt 12.

The purified melt 25 is flown out of the groove 24 for casting. If the original melt 12 is charged continuously into the shearing crucible 1, the purified melt 24 can be continuously flown out from the holding furnace 21.

Turning to FIG. 2A, this depicts in more detail a stirrer 5 for use in the device of FIG. 1. Stirrer 5 includes a shaft 30 (with the pipe 6 of FIG. 1 not shown) having at the distal end of shaft 30 four vanes 35 protruding radially from shaft 30 and equally distributed about the periphery of shaft 30.

FIG. 2B shows an alternative embodiment of stirrer 5 having shaft 30 and vanes 35 as shown in FIG. 2A but also having flange 40 disposed radially about shaft 30 and capping the top surface of vanes 35.

In use, rotation of stirrer 5 generates an eccentric flow against the wall of stator 8 and this results in high shear and localised turbulence which generates fine bubbles of the inert gas as the gas passes through holes 4.

In the following example, an aluminium alloy with a nominal composition of 9 wt. % Si, 4 wt. % Cu, 3 wt. % Zn and 0.3 wt. Mn is provided with different levels of Fe and Mn contents to demonstrate use of the method of the present invention for iron removal.

Table 1 shows the variation of individual elements in the original alloy before and after processing of iron removal. It can be seen that the concentration of the elements except Fe and Mn is very consistent and there is no apparent variation in the original alloy and in the alloy after iron removal. However, the change in the levels of Fe and Mn are different during processing. The Mn concentration is adjusted at different levels in order to promote the formation of (Fe, Mn)-rich intermetallics. After the processing of iron removal, the Fe concentration is consistently reduced to a low level in each alloy, although it is different from one to the other. However, the final Mn concentration is close to the level or within the levels required by the international standard specification, although the higher initial Mn concentration leads to a higher final Mn concentration. The ratio of Fe/Mn has clearly confirmed the changes of the relationship between Fe and Mn in the original alloy, before deferrization and after deferrization.

Furthermore, the partition coefficient confirms that the Mn has significant effect on the final Fe concentration in the purified alloy. A higher Mn concentration leads to a lower final Fe concentration in the final purified alloy, which corresponds to a lower partition coefficient. In other words, a high Fe/Mn ratio in the original alloy leads to a high iron residue in the purified aluminium alloy and therefore a lower effectiveness of iron removal. It is important to point out that the iron removal process is achieved after preferably not more than 3 minutes of shearing, more preferably not more than one minute.

TABLE 1
The effectiveness of iron removal and the associated Mn
content in Al-9 wt. % Si-4 wt. % Cu-3 wt. % Zn alloy.

| | Test | | | | | | | | Partition |
|---|---|---|---|---|---|---|---|---|---|
| | number | Fe | Mn | Si | Cu | Zn | Al | Fe/Mn | coefficient |
| Before | ex. 1 | 1.03 | 0.28 | 9.24 | 3.36 | 1.72 | 84.37 | 3.68 | |
| iron | ex. 2 | 1.15 | 0.88 | 9.17 | 3.43 | 1.73 | 83.64 | 1.30 | |
| removal | ex. 3 | 1.15 | 1.45 | 9.24 | 3.31 | 1.71 | 83.14 | 0.79 | |
| | ex. 4 | 1.05 | 1.95 | 9.29 | 3.42 | 1.75 | 82.54 | 0.54 | |
| After | ex. 1 | 0.70 | 0.15 | 8.81 | 3.46 | 1.73 | 85.15 | 4.63 | 0.68 |
| iron | ex. 2 | 0.48 | 0.29 | 8.86 | 3.48 | 1.72 | 85.18 | 1.66 | 0.41 |
| removal | ex. 3 | 0.36 | 0.31 | 8.84 | 3.41 | 1.73 | 85.36 | 1.17 | 0.31 |
| at 590° C. | ex. 4 | 0.29 | 0.44 | 8.78 | 3.49 | 1.74 | 85.27 | 0.65 | 0.27 |

Note:
all the compositions are in wt. %

1.-11. (canceled)

12. A device for separating impurities from an alloy melt, including:
(a) a rotor comprising a shaft having a first end and a second end, the shaft having a longitudinal channel with an inlet proximate the first end of the shaft and an outlet proximate the second end of the shaft to allow a fluid to flow into the channel through the inlet, through the shaft and out of the channel at the outlet,
(b) a motor to rotate the shaft about its longitudinal axis, and
(c) a stator in the form of a sleeve proximate the second end of the shaft, the sleeve having a wall with a plurality of apertures therein, wherein the rotor is encircled by a round stator, whereby in use fluid exiting the longitudinal channel of the shaft is able to pass through said apertures.

13. A device as claimed in claim 12, wherein the sleeve is a hollow cylinder.

14. A device as claimed in claim 12, wherein the apertures are distributed evenly around the sleeve wall.

15. A device as claimed in claim 12, wherein the motor is configured to rotate the shaft at rates from 1 rpm to 10000 rpm.

16. A method for separating impurities from an alloy melt, including the steps of:
(a) providing a melt of the alloy in a first vessel, and including the following steps in any order:
(b) deploying a device as recited in claim 1 and rotating the rotor in order to shear the melt,
(c) deploying a device as recited in claim 1 and supplying to the alloy melt an inert gas by causing said gas to flow along the longitudinal channel of said device from the first end to the second end of the shaft in order that the gas exits the shaft, forms gas bubbles in the alloy melt, and passes through the aperture in the sleeve wall, and
(d) reducing the temperature of the alloy melt to below its liquidus but above its solidus,
in order to cause impurities to collect at the top surface of the melt, at the bottom of the vessel or to dissolve in the gas bubbles.

17. A method as claimed in claim 16, additionally including the step of:
(e) after steps (a) to (d), transferring at least some of the alloy melt to a second vessel and leaving at least some impurities in the first vessel.

18. A method as claimed in claim 17 wherein the temperature of the alloy in the second vessel is maintained above its solidus but below its liquidus.

19. A method as claimed in claim 17, including the step of:
(f) after step (e), removing at least some of the alloy from the second vessel and leaving at least some impurities in the second vessel.

20. A method as claimed in claim 16, wherein the alloy is an aluminium alloy.

21. A method as claimed in claim 20, wherein the alloy additionally includes at least one element chosen from Si, Mn, Mg, Cr, Co and Ni.
